(19) United States
(12) Patent Application Publication
(10) Pub. No.: US 2025/0371514 A1
(43) Pub. Date: Dec. 4, 2025

(54) SYSTEM FOR PROCESSING A FINANCIAL TRANSACTION AND METHOD OF OPERATING THE SYSTEM

(71) Applicant: Wincor Nixdorf International GmbH, Paderborn (DE)

(72) Inventor: Jan Blotenburg, Randstad (NL)

(21) Appl. No.: 18/676,571

(22) Filed: May 29, 2024

(51) Int. Cl. G06Q 20/20; G06Q 40/10; G06Q 40/12

(52) U.S. Cl. CPC G06Q 20/207; G06Q 40/10; G06Q 40/123

(57) ABSTRACT

A system for processing a financial transaction can include at least one point of sale (POS) device, a database, and a compliance server. The POS device can receive data corresponding to a requested transaction and transmit the data, as well as data defined by the good or service and its physical location. The database can have a memory and can be configured to store a plurality of transaction preconditions, each associated with a governmental jurisdiction. At least some of the plurality of transaction preconditions can be further associated with a good or a service. The compliance server can receive the data from the POS device, retrieve at least one of the transaction preconditions that corresponds to the data, and transmit a relevant transaction precondition to the POS device. The POS device can adjust the requested transaction in response to receiving the relevant transaction precondition from the compliance server.

### BACKGROUND

### 1. Field

The present disclosure relates to systems for processing financial transactions and methods for operating such systems.

### 2. Description of Related Prior Art

U.S. Pub. No. 20230033585A1 discloses TAXATION ANALYSIS FOR PROPOSED TRANSACTIONS. The system disclosed in the '585 publication may be configured to obtain data associated with a transaction to be executed, obtain a request to determine a tax implication of the transaction, generate a first tax return (with the transaction being excluded from use in generating the first tax return), and generate a second tax return based on the request (with the transaction being included for use in generating the second tax return). The system may also be configured to compare the first tax return and the second tax return, generate one or more results associated with the transaction based on the comparison, and provide the one or more results. The one or more results may indicate an impact on total taxes owed, deductions, loss of tax credits, or other impacts caused by the proposed transaction.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

A system for processing a financial transaction can include at least one point of sale (POS) device, a database, and a compliance server. The at least one POS device can have one or more processors and can be configured to receive data corresponding to a requested transaction of at least one good or service by a purchaser. The at least one POS device can also be configured to transmit (i) the data corresponding to the requested transaction, (ii) secondary data defined by the at least one good or service to be purchased in the requested transaction, and (iii) a physical location of the at least one POS device. The database can have a memory and can be configured to store a plurality of transaction preconditions. Each of the plurality of transaction preconditions can be associated with one of a plurality of governmental jurisdictions. The physical location of the at least one POS device can be one of the plurality of governmental jurisdictions. At least some of the plurality of transaction preconditions can be further associated with a good or a service. The at least one good or service of the requested transaction can be among the goods and services associated with the at least some of the plurality of transaction preconditions stored in the database. The compliance server can have one or more processors and can be configured to receive, from the at least one POS device, less than all of the data corresponding to the requested transaction and the secondary data and the physical location of the at least one POS device. The compliance server can also be configured to retrieve at least one of the plurality of transaction preconditions from the database in response to receiving the data corresponding to the requested transaction and the secondary data and the physical location of the at least one POS device. The at least one of the plurality of transaction preconditions that is retrieved can correspond to at least one of the data corresponding to the requested transaction and the secondary data and the physical location of the at least one POS device. The compliance server can also be configured to determine that at least one of the data corresponding to the requested transaction and the secondary data and the physical location of the at least one POS device fulfills a first transaction precondition. The compliance server can also be configured to transmit, in response to determining at least one of the data corresponding to the requested transaction and the secondary data and the physical location of the at least one POS device fulfills a first transaction precondition of the at least one of the plurality of transaction preconditions, the first transaction precondition to the at least one POS device. The at least one POS device can adjust the requested transaction in response to receiving the first transaction precondition from the compliance server.

According to other features, at least one POS device can include at least one of a card reader, a cash register, a tablet computer, and a scanner. The data corresponding to the requested transaction can include an age of the purchaser. The secondary data can include an identity of the at least one good or service, a number of the good/service that is to be purchased, and an amount to be charged to the purchaser. At least one of the plurality of transaction preconditions can be univariable. At least one of the plurality of transaction preconditions can be multi-variable. At least some of the plurality of transaction preconditions can be regulations of the respective governmental jurisdiction. Neither the data corresponding to the requested transaction nor the secondary data may include a financial account of the purchaser. The compliance server may not receive data of a financial account of the purchaser.

In other features, the at least one POS device can adjust the requested transaction in response to receiving approval to execute the requested transaction from the compliance server by altering the transaction as it was defined before the at least one POS device transmitted the data corresponding to the requested transaction as well as secondary data defined by the at least one good or service to be purchased in the requested transaction and a physical location of the at least one POS device to the compliance server. The compliance server can be further configured to transmit a command to the at least one POS device to transmit further data to the compliance server in response to the compliance server not determining that any of the data corresponding to the requested transaction and the secondary data and the physical location of the at least one POS device fulfills any of the plurality of transaction preconditions retrieved from the database. The compliance server can be further configured to transmit a denial of the requested transaction to the at least one POS device in response to the compliance server not determining that the at least one of the data corresponding to the requested transaction and the secondary data and the physical location of the at least one POS device fulfill the at least one of the plurality of transaction preconditions retrieved from the database.

According to additional features, the database can be further configured to store a plurality of transaction postconditions. At least some of the plurality of transaction postconditions can be associated with one of the plurality of governmental jurisdictions. At least some of the plurality of transaction postconditions can be further associated with a good or a service. The at least one good or service of the requested transaction can be among the goods and services associated with the at least some of the plurality of transaction postconditions stored in the database.

According to other features, the compliance server can be further configured to retrieve at least one of the plurality of transaction postconditions from the database in response to receiving the data corresponding to the requested transaction and the secondary data and the physical location of the at least one POS device. The at least one of the plurality of transaction postconditions that is retrieved can correspond to at least one of the data corresponding to the requested transaction and the secondary data and the physical location of the at least one POS device. The compliance server can be further configured to determine whether at least one of the data corresponding to the requested transaction and the secondary data and the physical location of the at least one POS device fulfills the at least one of the plurality of transaction postconditions retrieved from the database. The compliance server can be further configured to transmit to the at least one POS device, with the approval, a command to be executed after completion of the requested transaction. The command can correspond to the at least one of the plurality of transaction postconditions retrieved from the database. The at least one POS device can be further configured to receive, from the compliance server, the command, and can be further configured to execute the command.

In other features, the command can be further defined as reporting the requested transaction to a government server. The command can be further defined as transmitting a tax payment to a government server. At least one of the plurality of transaction postconditions can be univariable. At least one of the plurality of transaction postconditions can be multi-variable.

According to additional features, the compliance server can be further configured to communicate with a government server at predetermined intervals to identify changes to any of the plurality of transaction preconditions. The compliance server can be further configured to modify the memory of the database to change any of the plurality of transaction preconditions in accordance with the changes identified by the government server.

A method of operating a system for processing a financial transaction can include receiving, at least one point of sale (POS) device having one or more processors, data corresponding to a requested transaction of at least one good or service by a purchaser. The method can also include transmitting, with the at least one POS device, the data corresponding to the requested transaction as well as secondary data defined by the at least one good or service to be purchased in the requested transaction and a physical location of the at least one POS device. The method can also include storing, in a database having a memory, a plurality of transaction preconditions. Each of the plurality of transaction preconditions can be associated with one of a plurality of governmental jurisdictions. The physical location of the at least one POS device can be one of the plurality of governmental jurisdictions. At least some of the plurality of transaction preconditions can be further associated with a good or a service. The at least one good or service of the requested transaction can be among the goods and services associated with the at least some of the plurality of transaction preconditions stored in the database. The method can also include receiving, with a compliance server having one or more processors, from the at least one POS device, the data corresponding to the requested transaction and the secondary data and the physical location of the at least one POS device. The method can also include retrieving, with the compliance server, at least one of the plurality of transaction preconditions from the database in response to receiving the data corresponding to the requested transaction and the secondary data and the physical location of the at least one POS device. At least one of the plurality of transaction preconditions that is retrieved can correspond to at least one of the data corresponding to the requested transaction and the secondary data and the physical location of the at least one POS device. The method can also include determining, with the compliance server, whether at least one of the data corresponding to the requested transaction and the secondary data and the physical location of the at least one POS device fulfill the at least one of the plurality of transaction preconditions retrieved from the database. The method can also include transmitting, with the compliance server, an approval to execute the requested transaction to the at least one POS device in response to the determining that the at least one of the data corresponding to the requested transaction and the secondary data and the physical location of the at least one POS device fulfill the at least one of the plurality of transaction preconditions retrieved from the database. The method can also include receiving, with the at least one POS device, approval to execute the requested transaction from the compliance server. The method can also include adjusting, with the at least one POS device, the requested transaction in response to the receiving.

According to other features, the transmitting with the at least one POS device can be further defined as transmitting, with the at least one POS device, no data of a financial account of the purchaser to the compliance server.

### BRIEF DESCRIPTION OF THE DRAWINGS

The detailed description set forth below references the following drawings:

FIG. 1 is a schematic of a system for processing a financial transaction according to an exemplary embodiment of the present disclosure;

FIG. 2 is a schematic of a compliance server of a system for processing a financial transaction according to an exemplary embodiment of the present disclosure; and

FIG. 3 is a simplified flow diagram of a method of operating a system for processing a financial transaction according to an exemplary embodiment of the present disclosure.

### DETAILED DESCRIPTION

The present disclosure, as demonstrated by the exemplary embodiment described below, can provide a system for processing a financial transaction and a method of operating such a system. The system can complement and supplement other financial transaction processing systems, specifically by providing point of sale systems with a service for ensuring compliance with legal and requirements relevant to the jurisdiction(s) in which sales occur. The system disclosed herein provides such support as service, a Communications Platform as a Service or CPaaS. Legal and fiscal compliance is a vital requirement for retailers in their business expansion to open markets in various countries. It is mandatory to comply to legislation and pass audits by governments.

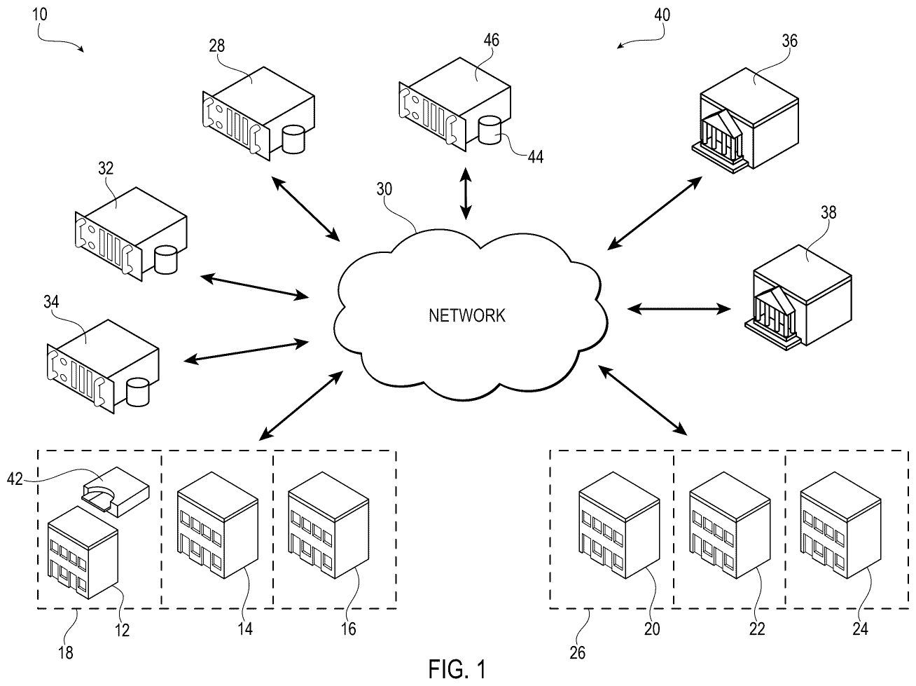

FIG. 1 schematically shows an operating environment 10 in which financial transactions are communicated and processed. An exemplary retail location of a first merchant is referenced at 12. Exemplary retail locations of a second merchant and a third merchant are respectively referenced at 14 and 16. The exemplary retail locations 12, 14, 16 are all located in the same governmental jurisdiction, referenced at 18. FIG. 1 also schematically shows exemplary retail locations 20, 22, 24, each from respective, different merchants, located in the same governmental jurisdiction 26, but the governmental jurisdiction 26 is different than the governmental jurisdiction 18.

FIG. 1 also schematically shows an exemplary merchant server referenced at 28. The exemplary merchant server 28 is an exemplary computing device and has one or more processors. The exemplary merchant server 28 may in some embodiments be implemented using one or more networked computers or other electronic devices, whether located locally with respect to one another or remotely with respect to one another. The exemplary merchant server 28 can include a central processing unit (CPU) including at least one microprocessor coupled to a memory, which may represent random access memory (RAM). The exemplary merchant server 28 can include one or more interfaces/transceivers for interconnecting with one or more networks (e.g., a LAN, a WAN, a wireless network, and/or the Internet, among others) to permit the communication of information to other computing devices. The exemplary merchant server 28 can operate under the control of an operating system, kernel and/or firmware and can execute or otherwise rely upon various computer software applications, components, programs, objects, modules, data structures, etc.

The exemplary merchant server 28 and the exemplary retail location 12 are associated with the same merchant. The exemplary merchant server 28 and the exemplary retail location 12 communicate with one another over an exemplary network 30. By way of example and not limitation, the exemplary retail location 12 can transmit records of sales to the exemplary merchant server 28. By way of example and not limitation, the exemplary merchant server 28 can transmit to the exemplary retail location 12 data that is associated with the products that are offered for sale in the exemplary retail location 12.

The exemplary network 30, that is illustrated schematically, can include a local area network (LAN), a wide area network (WAN), e.g., the Internet, a Multi-protocol label switching (MPLS) network, a cellular network such as operated by cellular phone companies, or any combination thereof. The exemplary network 30 can be practiced with a wireless network, a hard-wired network, or any combination thereof. The exemplary network 30 can be, in part, a financial switching/bank network such as NYCE, PULSE, PLUS, Cirrus, AFFN, Interac, Interswitch, STAR, LINK, MegaLink, or BancNet. The present disclosure is well suited to a wide variety of computer network systems over numerous topologies. Within this field, the configuration and management of large networks comprise storage devices and computers that are communicatively coupled to dissimilar computers and storage devices over a network.

FIG. 1 also schematically shows an exemplary guarantor server referenced at 32. The exemplary guarantor server 32 is an exemplary computing device and has one or more processors. With respect to hardware and software generally, the exemplary guarantor server 32 can be similar to the exemplary merchant server 28, while the respective servers 28 and 32 execute different functionalities and operations. The exemplary guarantor server 32 can be a bank core or another kind of financial guarantor. The exemplary guarantor server 32 and the exemplary retail location 12 communicate with one another over a secure portion of the exemplary network 30, such as a financial switching/bank portion of the network 30. By way of example and not limitation, the exemplary retail location 12 can transmit financial details of a pending, proposed transaction to the exemplary guarantor server 32. The financial details can include an identity of a purchaser, an account of the purchaser that is held by the exemplary guarantor server 32, and the amount that will be deducted from the account if the proposed transaction is approved. In sending the financial details of the proposed transaction, the exemplary retail location 12 is seeking approval of the proposed transaction from the exemplary guarantor server 32. In response to receiving the financial details of the proposed transaction, the exemplary guarantor server 32 fetches the details of the account, determines if the account has sufficient funds for the proposed transaction, confirms that the identity and authority of the purchaser, and transmits to the exemplary retail location 12 over the network 30 an approval or a rejection of the proposed transaction.

FIG. 1 also schematically shows an exemplary vendor server referenced at 34. The exemplary vendor server 34 is an exemplary computing device and has one or more processors. With respect to hardware and software generally, the exemplary vendor server 34 can be similar to the exemplary merchant server 28, while the respective servers 28 and 34 execute different functionalities and operations. The exemplary vendor server 34 can be the server of a vendor that produces goods sold in the exemplary retail location 12. The exemplary vendor server 34 and the exemplary retail location 12 communicate with one another over the exemplary network 30. By way of example and not limitation, the exemplary retail location 12 can transmit some details of a pending, proposed transaction to the exemplary vendor server 34 when the purchaser seeks to use a coupon or voucher to reduce or eliminate the amount that the purchaser will pay for the good. These details can include an identity of the good being purchased and a reference to a voucher or coupon that is to be applied. The voucher/coupon will have been issued by the vendor and honored by the vendor. The voucher/coupon reference can be an alphanumeric string of characters. In sending these details of the proposed transaction, the exemplary retail location 12 is seeking approval from the exemplary vendor server 34 to apply the voucher/coupon and reduce the amount of the transaction. In response to receiving the details, the exemplary vendor server 34 fetches the details of the reference, determines if the reference corresponds to a voucher/coupon previously issued by the vendor, and transmits to the exemplary retail location 12 an approval or a rejection of application of the voucher/coupon presented by the purchaser.

FIG. 1 also schematically shows exemplary government servers referenced at 36 and 38. The exemplary government servers 36, 38 are exemplary computing device and each has one or more processors. With respect to hardware and software generally, the exemplary government servers 36, 38 can be similar to the exemplary merchant server 28, while the respective servers 28 and 36, 38 execute different functionalities and operations. The exemplary government servers 36, 38 can be the server of the respective government in which the exemplary retail locations are located. The exemplary government server 36 can be associated with the governmental jurisdiction 18 and the exemplary government server 38 can be associated with the governmental jurisdiction 26. The exemplary government servers 36, 38 can communicate with other computing devices over the network 30.

FIG. 1 also shows an exemplary system for processing a financial transaction in the operating environment that is referenced at 40. The exemplary system 40 includes at least one point of sale (POS) device that has one or more processors. An exemplary POS device is referenced at 42 and illustrated, by way of example and not limitation, as a card reader associated with the retail location 12. A POS device that can be a component of an embodiment of the present disclosure can include a card reader, a cash register, a tablet computer, a scanner and/or any other device that is known to be utilized in POS settings. It is noted that, while not shown, all of the other exemplary retail locations 14, 16, 20, 22, 24 can include at least one POS device. It is further noted that all of the disclosure associated with retail location 12 is applicable to all of the other exemplary retail locations 14, 16, 20, 22, 24.

The exemplary POS device 42 is configured to transmit data to the exemplary merchant server 28 for the purposes disclosed above. The exemplary POS device 42 is configured to transmit data to the exemplary guarantor server 32 for the purposes disclosed above. The exemplary POS device 42 is configured to transmit data to the exemplary vendor server 34 for the purposes disclosed above.

The exemplary POS device 42 is configured to receive data corresponding to a requested transaction of at least one good or service by a purchaser. The data corresponding to the requested transaction of the at least one good or service by the purchaser will from this point on be designated as the “purchaser data.” The purchaser data can be received, at least in part, from the purchaser. The purchaser data may be received in total from the purchaser. By way of example and not limitation, the purchaser data can include the identity of the purchaser, an age of the purchaser, an account to be charged against for the requested transaction, a personal identification number (“PIN”), and/or a token such a two-dimensional bar code (also known as a quick response (QR) code). In one or more embodiments of the present disclosure, purchaser data is data that is dependent on one or more attributes of the purchaser.

The exemplary POS device 42 is also configured to transmit the purchaser data as well as secondary data. The purchaser data and the secondary data can be transmitted to other computing devices in order to further assessment and completion of the requested transaction, as will be disclosed in greater detail below. In one or more embodiments of the present disclosure, secondary data is data that is independent of the purchaser. The secondary data can be defined by the at least one good or service to be purchased in the requested transaction. By way of example and not limitation, the secondary data can include the identity of the good or service that is to be purchased, a number of the good/service that is to be purchased, and/or an amount to be charged to the purchaser for the good/service. The exemplary POS device 42 is also configured to transmit the physical location of said exemplary POS device 42.

The exemplary system 40 also includes an exemplary database 44 having a memory. The exemplary database 44 is configured to store a plurality of transaction preconditions. Each transaction precondition is a condition that must be satisfied at the time the requested transaction is initiated or must be satisfied by the purchaser before the transaction is approved and executed. A transaction may require more than one form approval. For example, a particular transaction may require approval from the guarantor server 32 and the vendor server 34. In one or more embodiments of the present disclosure, the requested transaction cannot be executed and completed unless the requested transaction has been approved. The system 40 can be operated such that one or more of the transaction preconditions must be satisfied before data associated with the requested transaction is transmitted to other computing devices by the exemplary POS device 42. The system 40 can also be operated such that one or more of the transaction preconditions is satisfied after data associated with the requested transaction is initially transmitted to other computing devices by the exemplary POS device 42.

One or more of the plurality of transaction preconditions can be “universal” and applicable to all goods. For example, an exemplary transaction precondition can be a tax rate applicable to all goods. One or more of the plurality of transaction preconditions can be associated with a particular good or a service. By way of example and not limitation, an exemplary transaction precondition can be applicable when a requested transaction involves the purchase of a good that cannot be purchased by children.

At least some of the transaction preconditions can be governmental or regulatory in nature. One or more of the plurality of transaction preconditions can be associated with one of a plurality of governmental jurisdictions 18 and/or 26. By way of example and not limitation, an exemplary transaction precondition can be a tax rate that will be applied to the requested transaction based on the particular good being purchased and will be applied if the transaction is executed. The exemplary database 44 can store a single tax rate that may be applicable to all goods and services or can store a plurality of different tax rates that are each applicable to a particular good/service or to a particular group of goods/services.

Another exemplary transaction precondition can be a sales restriction that is dependent on the purchaser, such as a minimum age requirement for purchasing a particular good or service. Another exemplary transaction precondition can be a requirement that the purchaser hold some form of license. For example, only a doctor may be permitted to purchase a material that is used to prepare medications. Another exemplary transaction precondition that can be characterized as a sales restriction that is dependent on the purchaser is a requirement associated with the past of the purchaser. For example, a purchaser previously convicted of a crime may not be permitted to purchase weapons or ammunition.

Other exemplary transaction preconditions can be sales restrictions that are independent of the purchaser. By way of example and not limitation, an exemplary transaction precondition can be sales restriction that precludes the purchase of a particular good on a particular day or time of day. For example, an exemplary transaction precondition can be that alcohol cannot be purchased on Sundays or cannot be purchased after midnight. Another exemplary transaction precondition that can be characterized as a sales restriction that is independent of the purchaser is a limitation on the amount of a particular good that can be purchased at one time. For example, during a pandemic, a purchaser may only be permitted to purchase one package of paper products.

The exemplary transaction preconditions noted above are generally single-variable or univariable transaction preconditions. Other exemplary transaction preconditions can be multi-variable. Continuing some of the examples noted above, a first exemplary transaction precondition can be that the purchaser has a particular license and a second exemplary transaction precondition can be a limitation on the amount of a particular good that can be purchased at one time. These two exemplary transaction preconditions can be combined to define a third exemplary transaction precondition. Specifically, a particular purchaser, even having a license, can only purchase a predetermined quantity of a particular good in a single transaction. Exemplary transaction preconditions can be further defined by additional dimensions. Continuing the present example, a fourth exemplary transaction precondition can be that (i) a particular purchaser, even having a license, (ii) can only purchase a predetermined quantity of a particular good in a single transaction, and (iii) can only execute a predetermined number of transactions over a predetermined period of time. Such multi-dimensional transaction preconditions can inhibit crime and fraudulent activity.

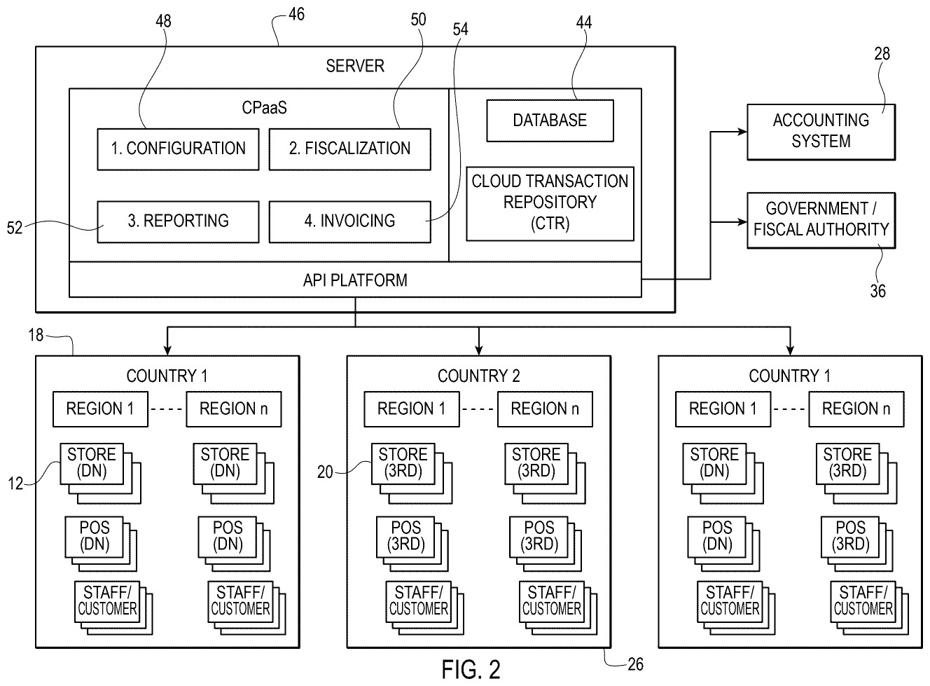

The exemplary system 40 also includes an exemplary compliance server 46 having one or more processors. With respect to hardware and software generally, the exemplary compliance server 46 can be similar to the exemplary merchant server 28, while the respective servers 28 and 46 execute different functionalities and operations. The exemplary compliance server 46 receives data associated with proposed transactions from the exemplary POS device 42 and searches the exemplary database 44 for applicable transaction preconditions. FIG. 2 is a schematic of the exemplary compliance server 46. The exemplary compliance server 46 includes a localization or configuration module 48. The exemplary configuration module 48 can manage the application of cash limits; confirm appropriate rounding operations; maintain selling restrictions; substantiate formatting such as currency symbol and position, number and date formats; validate taxes and tax rate; present any return limitations and handling (i.e. restricting payment method for returns, limit for days for returns etc.); and establish and enforce transaction numbering policies. The exemplary compliance server 46 also includes a fiscalization module 50. The exemplary fiscalization module 50 can send transaction details to a governmental/fiscal authority to a fiscal printer; validate of legal requirements for non-fiscal countries (i.e. cash limit UK); perform initialization (i.e. time difference handling between POS and a printer); and generate Z-reports and X-reports. The exemplary compliance server 46 also includes a reporting module 52. The exemplary reporting module 52 can perform digital signing (i.e. FR, NO), electronic journaling, data export, and document fiscal numbering. The exemplary compliance server 46 also includes an invoicing module 54. The exemplary invoicing module 54 can creating and managing invoices, make corrections to invoices, and generate e-invoices.

The exemplary compliance server 46 is configured to receive, from the exemplary POS device 42, less than all of the purchaser data, the secondary data, and the physical location of the exemplary POS device 42. Regarding the purchaser data, the exemplary POS device 42 can transmit the identity of the purchaser and the age of the purchaser, which is partial purchaser data. The POS device 42 does not transmit any financial data of the purchaser to the exemplary compliance server 46, including the financial account of the purchaser, any PIN that is submitted, and any other data related to the purchaser's finances.

In response to receiving the data from the exemplary POS device 42, the exemplary compliance server 46 is also configured to search the exemplary database 44. The exemplary compliance server 46 can retrieve any of the plurality of transaction preconditions from the exemplary database 44 that corresponds to the data received from the exemplary POS device 42. The exemplary compliance server 46 can search the exemplary database 44 to match the elements of data received from the POS device 42 with any of the applicable, stored transaction preconditions. In each matching, the exemplary compliance server 46 is determining that at least one of the partial purchaser data, the secondary data, and the physical location of the exemplary POS device 42 fulfills the transaction precondition that is matched.

In the exemplary embodiment of the present disclosure, the physical location of the POS device 42 corresponds to at least one transaction precondition that is stored in the exemplary database 44. For example, the database 44 can store a transaction precondition that any transaction from the POS device 42 corresponds to governmental jurisdiction 18 and, for the transaction to be completed, the tax rate of the government associated with the government server 36 must be applied. The exemplary compliance server 46 can transmit the tax rate of the government associated with the government server 36 to the POS device 42 so that the tax rate can be applied if the transaction is completed.

In one or more transactions, only the physical location of the exemplary POS device 42 may match a transaction precondition. For example, no element of data received by the exemplary compliance server 46 other than the physical location invokes a transaction precondition stored in the exemplary database 44. In one or more other transactions, one element in addition to the physical location of the exemplary POS device 42 but less than all of the elements of data may match one or more transaction preconditions. In one or more other transactions, all of the elements of data may match one or more transaction preconditions.

In response to determining that at least one of the purchaser data, the secondary data, and the physical location of the exemplary POS device 42 fulfills a first transaction precondition of the plurality of transaction preconditions, the exemplary compliance server 46 can transmit the first transaction precondition to the exemplary POS device 42. By way of example and not limitation, the first transaction precondition can be the tax rate that will be applied to the requested transaction if the transaction is executed. This tax rate matches the physical location of the exemplary POS device 42.

The exemplary POS device 42 can adjust the requested transaction in response to receiving the first transaction precondition from the exemplary compliance server 46. To adjust refers to altering the transaction as it was defined before the exemplary POS device 42 communicated data to the exemplary compliance server 46. The adjustment can be a plurality of different actions, such as adding the appropriate sales tax which would not require further information from the purchaser, or directing the POS device to check or recheck the identification of the purchaser, or directing the POS device to confirm that the purchaser has a license, or directing the POS device to reduce the amount of the good being purchased, by way of example and not limitation. In another non-limiting example, if the first transaction precondition is the tax rate to be applied, the adjustment is the change to the amount to be charged to the purchaser's account to include the required tax.

The exemplary compliance server 46 is further configured to transmit a command to the exemplary POS device 42 after and in response to the data received from the exemplary POS device 42. More specifically, in one or more embodiments of the present disclosure, the exemplary compliance server 46 can transmit a command to the exemplary POS device 42 after and in response to the exemplary compliance server 46 not determining that any of the purchaser data, the secondary data, or the physical location of the exemplary POS device 42 fulfills, or matches, any of the plurality of transaction preconditions that was retrieved from the exemplary database 44. The command transmitted by the exemplary compliance server 46 can be a command to transmit further data to the exemplary compliance server 46. In non-limiting example, the exemplary POS device 42 may transmit its country of location to the exemplary compliance server 46. The exemplary country can include a plurality of regions (as shown in FIG. 2) and each region can have its own tax rate. The command transmitted by the exemplary compliance server 46 can be a command to transmit the region of the exemplary POS device 42. In an alternative way of processing, the exemplary compliance server 46 can transmit a denial of the requested transaction to the exemplary POS device 42 instead of, or in addition to, a command to transmit additional information.

The exemplary database 44 is further configured to store a plurality of transaction postconditions. At least some of the plurality of transaction postconditions can be associated with one of the plurality of governmental jurisdictions and/or with a good or a service. Each transaction postcondition is an action that is performed by the exemplary system 40 when the requested transaction has been completed. At least some of the transaction postconditions can be governmental or regulatory in nature. Transaction postconditions can be univariable or multi-variable. By way of example and not limitation, an exemplary transaction postcondition can be the transmission of tax payment to a government exemplary compliance server 46 after the transaction has been executed. The amount of the tax payment will have been collected by the exemplary system 40 upon completion of the requested transaction. The exemplary system 40 can operate such that one or more transaction postconditions can be transmitted to the exemplary POS device 42 from the exemplary compliance server 46 when one or more transaction preconditions are sent.

By way of example and not limitation, the exemplary POS device 42 can transmit, to the exemplary compliance server 46, data associated with a present transaction, purchaser data, secondary data, a POS location data. The exemplary compliance server 46 can search the exemplary database 44 and determine that one or more transaction preconditions are applicable, such as the appropriate tax rate to apply. The exemplary database 44 can associate transaction preconditions with transaction postconditions. By way of example and not limitation, the transaction precondition indicating the tax rate, and thus taxes that must be paid, can be associated with a transaction postcondition that indicates that the taxes paid are to be transmitted to the appropriate government server, such as government server 36 or 38. After the transaction is completed, the exemplary POS device 42 can report the sale to the merchant server 28 and, at the same time or approximately the same time, can transmit the transaction postcondition to the merchant server 28. The merchant server 28 can then execute the command and transmit the payment of taxes to the appropriate government server.

Another exemplary transaction postcondition can be the reporting of various details of the requested transaction to a government server after the transaction has been executed. For example, if the good purchased is scarce, an exemplary transaction postcondition can be a command to report the amount of the good sold during the requested transaction to the government server so that the government can maintain accurate data regarding availability of the good. This would be an example of a single variable transaction postcondition, specifically the sale of a particular, scarce good.

In another example, exemplary transaction postcondition can be the reporting of a particular purchaser and the nature of the good purchased. For example, the reporting can be made in response to a purchaser who possesses a particular license and who purchases a particular quantity of goods, such as, by way of example and not limitation, chemicals. This would be an example of a multi-variable transaction postcondition, specifically the sale of a particular good and a particular purchaser.

As with transaction preconditions, the exemplary compliance server 46 is configured to retrieve transaction postconditions from the exemplary database 44 in response to receiving the partial purchaser data, the secondary data, and the physical location of the exemplary POS device 42. The exemplary compliance server 46 is also configured to determine whether any of the elements of received data fulfills or matches any of the plurality of transaction postconditions that is retrieved from the exemplary database 44. The exemplary compliance server 46 is also configured to transmit, to the exemplary POS device 42, with the first transaction precondition, a command to be executed after completion of the requested transaction that corresponds to a transaction postcondition. The exemplary POS device 42 is further configured to receive the command and execute the command.

The exemplary compliance server 46 can be further configured to communicate with one or more government servers. The exemplary compliance server 46 can communicate with one or more government servers at predetermined intervals to identify any changes that must be made to any of the plurality of transaction preconditions. By way of example, tax rates can change and the exemplary compliance server 46 can update transaction preconditions and postconditions by modifying the memory of the exemplary database 44 in accordance with the changes identified by the government server. In one or more embodiments of the present disclosure, the exemplary compliance server 46 can communicate with government servers that hold criminal conviction data so that the exemplary compliance server 46 can check the identity of the purchaser against such data.

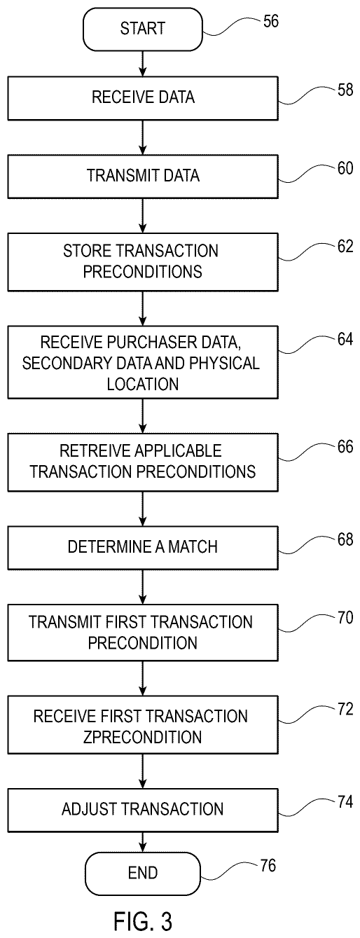

A simplified flow diagram of a method of operating the exemplary system 40 is shown in FIG. 3. The method begins at 56. At 58, the exemplary POS device 42 receives data corresponding to a requested transaction. The data can be elements associated with the purchaser (purchaser data) and elements associated with the good or service being purchased (secondary data). At 60, the exemplary POS device 42 transmits part of the purchaser data, the secondary data, and the physical location of the exemplary POS device 42. At 62, the exemplary database 44 stores the transaction preconditions, each associated with one of a plurality of governmental jurisdictions. It is noted that all of the actions set forth in the flow diagram of FIG. 3 are not dictated in a particular order. At 64, the exemplary compliance server receives the partial purchaser data, the secondary data, and the physical location of the exemplary POS device 42.

At 66, the exemplary compliance server 46 attempts to retrieve any of the transaction preconditions stored in the exemplary database 44 that correspond to or match any of the purchaser data, the secondary data, and the physical location of the exemplary POS device 42. It is noted that the exemplary compliance server 46 may also attempt to retrieve any of the transaction postconditions stored in the exemplary database 44 that correspond to or match any of the purchaser data, the secondary data, and the physical location of the exemplary POS device 42 during action 66. In making a match, the exemplary compliance server 46 determines that at least one of the purchaser data, the secondary data, and the physical location of the exemplary POS device 42 fulfills at least one of the plurality of transaction preconditions retrieved from the exemplary database 44, as referenced at 68.

At 70, the exemplary compliance server 46 transmits a first transaction precondition, determined to be a match to the data that was received at 64, to the exemplary POS device 42. It is noted that the exemplary compliance server 46 may also transmit any of the transaction postconditions during action 70. At 72, the exemplary POS device 42 receives the first transaction precondition from the exemplary compliance server 46. At 74, the exemplary POS device 42 adjusts the requested transaction in response to the first transaction precondition received at 72. The method ends at 76.

It is noted that the exemplary POS device 42 can transmit data to the various servers disclosed above when a transaction is initiated by a purchaser. For example, the exemplary POS device 42 can transmit, generally concurrently, a message to the exemplary compliance server 46 including the partial purchaser data, the secondary data, and the physical location. The exemplary POS device 42 does not transmit financial data to the exemplary compliance server 46. The exemplary POS device 42 can also transmit data associated with a voucher/coupon to the exemplary vendor server 34 in order to validate a voucher/coupon presented by the purchaser. The exemplary POS device 42 can also transmit financial data to the exemplary guarantor server 32 in order to gain approval of the transaction.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventor and such statements themselves are not prior art or admissions as to what is prior art.

A “service,” as used herein, includes logic but is not limited to hardware, firmware, software and/or combinations of each to perform a function(s) or an action(s), and/or to cause a function or action from another component. For example, based on a desired application or need, a service applying logic may include a software controlled microprocessor, discrete logic such as an application specific integrated circuit (ASIC), a programmable/programmed logic device, memory device containing instructions, or the like, or combinational logic embodied in hardware. Logic for performing a service may also be fully embodied as software that performs the desired functionality when executed by a processor.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventor also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. A system for processing a financial transaction comprising:
at least one point of sale (POS) device having one or more processors and configured to:
receive data corresponding to a requested transaction of at least one good or service by a purchaser, and
transmit the data corresponding to the requested transaction as well as secondary data defined by the at least one good or service to be purchased in the requested transaction and a physical location of said at least one POS device;
a database having a memory and configured to store a plurality of transaction preconditions, each of the plurality of transaction preconditions associated with one of a plurality of governmental jurisdictions, the physical location of said at least one POS device being one of the plurality of governmental jurisdictions, wherein at least some of the plurality of transaction preconditions are further associated with a good or a service, wherein the at least one good or service of the requested transaction is among the goods and services associated with the at least some of the plurality of transaction preconditions stored in said database;
a compliance server having one or more processors and configured to:
receive, from said at least one POS device, less than all of the data corresponding to the requested transaction and the secondary data and the physical location of said at least one POS device,
retrieve at least one of the plurality of transaction preconditions from said database in response to receiving the data corresponding to the requested transaction and the secondary data and the physical location of said at least one POS device, the at least one of the plurality of transaction preconditions that is retrieved corresponds to at least one of the data corresponding to the requested transaction and the secondary data and the physical location of said at least one POS device,
determine that at least one of the data corresponding to the requested transaction and the secondary data and the physical location of said at least one POS device fulfills a first transaction precondition of the plurality of transaction preconditions stored in said database, and
transmit, in response to determining at least one of the data corresponding to the requested transaction and the secondary data and the physical location of said at least one POS device fulfills a first transaction precondition of the at least one of the plurality of transaction preconditions, the first transaction precondition to said at least one POS device; and
wherein said at least one POS device adjusts the requested transaction in response to receiving the first transaction precondition from said compliance server.

2. The system of claim 1 wherein said at least one POS device includes at least one of a card reader, a cash register, a tablet computer, and a scanner.

3. The system of claim 1 wherein:
the data corresponding to the requested transaction includes an age of the purchaser; and
the secondary data includes an identity of the at least one good or service, a number of the good/service that is to be purchased, and an amount to be charged to the purchaser.

4. The system of claim 1 wherein at least one of the plurality of transaction preconditions is univariable.

5. The system of claim 1 wherein at least one of the plurality of transaction preconditions is multi-variable.

6. The system of claim 1 wherein at least some of the plurality of transaction preconditions are regulations of the respective governmental jurisdiction.

7. The system of claim 1 wherein the secondary data does not include a financial account of the purchaser.

8. The system of claim 1 wherein said compliance server does not receive data of a financial account of the purchaser.

9. The system of claim 1 wherein said at least one POS device adjusts the requested transaction in response to receiving the first transaction precondition from said compliance server by altering the transaction as it was defined before said at least one POS device transmitted the data corresponding to the requested transaction as well as the secondary data defined by the at least one good or service to be purchased in the requested transaction and a physical location of said at least one POS device to said compliance server.

10. The system of claim 1 wherein said compliance server is further configured to transmit a command to said at least one POS device to transmit further data to said compliance server in response to said compliance server not determining that the at least one of the data corresponding to the requested transaction and the secondary data and the physical location of said at least one POS device fulfills any of the at least one of the plurality of transaction preconditions.

11. The system of claim 1 wherein said compliance server is further configured to transmit a denial of the requested transaction to said at least one POS device in response to said compliance server not determining that the at least one of the data corresponding to the requested transaction and the secondary data and the physical location of said at least one POS device fulfill the at least one of the plurality of transaction preconditions retrieved from said database.

12. The system of claim 1 wherein said database is further configured to store a plurality of transaction postconditions, at least some of the plurality of transaction postconditions associated with one of the plurality of governmental jurisdictions, wherein at least some of the plurality of transaction postconditions are further associated with a good or a service, wherein the at least one good or service of the requested transaction is among the goods and services associated with the at least some of the plurality of transaction postconditions stored in said database.

13. The system of claim 12 wherein:
said compliance server is further configured to:
retrieve at least one of the plurality of transaction postconditions from said database in response to receiving the data corresponding to the requested transaction and the secondary data and the physical location of said at least one POS device, the at least one of the plurality of transaction postconditions that is retrieved corresponds to at least one of the data corresponding to the requested transaction and the secondary data and the physical location of said at least one POS device,
determine whether at least one of the data corresponding to the requested transaction and the secondary data and the physical location of said at least one POS device fulfill the at least one of the plurality of transaction postconditions retrieved from said database, and
transmit to said at least one POS device, with the approval, a command to be executed after completion of the requested transaction, the command corresponding to the at least one of the plurality of transaction postconditions retrieved from said database;
said at least one POS device is further configured to:
receive, from said compliance server, the command, and
execute the command.

14. The system of claim 13 wherein the command is further defined as reporting the requested transaction to a government server.

15. The system of claim 13 wherein the command is further defined as transmitting a tax payment to a government server.

16. The system of claim 12 wherein at least one of the plurality of transaction postconditions is univariable.

17. The system of claim 12 wherein at least one of the plurality of transaction postconditions is multi-variable.

18. The system of claim 1 wherein said compliance server is further configured to:
communicate with a government server at predetermined intervals to identify changes to any of the plurality of transaction preconditions; and
modify said memory of said database to change any of the plurality of transaction preconditions in accordance with the changes identified by the government server.

19. A method of operating a system for processing a financial transaction comprising:
receiving, at least one point of sale (POS) device having one or more processors, data corresponding to a requested transaction of at least one good or service by a purchaser;
transmitting, with the at least one POS device, only part of the data corresponding to the requested transaction as well as secondary data defined by the at least one good or service to be purchased in the requested transaction and a physical location of the at least one POS device;
storing, in a database having a memory, a plurality of transaction preconditions, each of the plurality of transaction preconditions associated with one of a plurality of governmental jurisdictions, the physical location of the at least one POS device being one of the plurality of governmental jurisdictions, wherein at least some of the plurality of transaction preconditions are further associated with a good or a service, wherein the at least one good or service of the requested transaction is among the goods and services associated with the at least some of the plurality of transaction preconditions stored in the database;
receiving, with a compliance server having one or more processors, from the at least one POS device, the data corresponding to the requested transaction and the secondary data and the physical location of the at least one POS device;
retrieving, with the compliance server, at least one of the plurality of transaction preconditions from the database in response to receiving the data corresponding to the requested transaction and the secondary data and the physical location of the at least one POS device, wherein the at least one of the plurality of transaction preconditions that is retrieved corresponds to at least one of the data corresponding to the requested transaction and the secondary data and the physical location of the at least one POS device;
determining, with the compliance server, that at least one of the data corresponding to the requested transaction and the secondary data and the physical location of the at least one POS device fulfills a first transaction precondition of the plurality of transaction preconditions retrieved from the database;
transmitting, with the compliance server, the first transaction precondition to the at least one POS device in response to said determining;
receiving, with the at least one POS device, the first transaction precondition from the compliance server; and
adjusting, with the at least one POS device, the requested transaction in response to said receiving.

20. The method of claim 19 wherein said transmitting with the at least one POS device is further defined as:
transmitting, with the at least one POS device, no data of a financial account of the purchaser to the compliance server.
